(19) United States
(12) Patent Application Publication
(10) Pub. No.: US 2025/0149221 A1
(43) Pub. Date: May 8, 2025

(54) CONTROL DEVICE WITH INTEGRATED ENERGY CONDITIONING AND INTEGRATED ENERGY MANAGEMENT

(71) Applicant: Sitema GmbH 7 Co. KG, Karlsruhe (DE)

(72) Inventors: Thomas Haase, Steinweiler (DE); Andreas Kiss, Wallbach (CH)

(73) Assignee: Sitema GmbH & Co. KG, Karlsruhe (DE)

(21) Appl. No.: 18/936,078

(22) Filed: Nov. 4, 2024

(30) Foreign Application Priority Data
Nov. 2, 2023 (DE) 102023130359.7

(51) Int. Cl. H01F 7/06; H02J 3/00; H02J 3/18

(52) U.S. Cl. CPC H01F 7/064; H02J 3/0012; H02J 3/1835

(57) ABSTRACT

A control device with integrated energy conditioning and energy management for actuating an electrically operated and/or controlled actuator, including: a controller for generating an actuation signal for the actuator; a connection for connecting the control device to an external electrical energy supply that provides a grid voltage; a circuit arrangement for the conditioning, rectification and conversion of the grid voltage into a first intermediate circuit DC voltage, a level of which is independent of a level of the grid voltage; at least one electrical buffer store for the first intermediate circuit DC voltage for buffering a power necessary for maintaining a further voltage, derived from the first intermediate circuit DC voltage, for supplying power to the controller unit in the event of failure of the external electrical energy supply and for transferring the actuator to a safe state, for example upon failure of the external electrical energy supply.

### CROSS-REFERENCE TO RELATED APPLICATIONS

this application claims priority from German patent application no. 10 2023 130 359.7, filed Nov. 2, 2023, which is incorporated herein by reference as if fully set forth.

### TECHNICAL FIELD

The invention relates to a control device with integrated energy conditioning and integrated energy management for actuating an electrically operated and/or controlled actuator.

### BACKGROUND

The products of the applicant, which are usually operated hydraulically or pneumatically, allow the clamping, securing, braking, holding, fixing and also the emergency braking of axially moved loads in the entire field of mechanical engineering. There are growing market requirements not only to electrify these products and security concepts, but also to equip them with additional functions and interfaces and digitize them. The electrification of the existing products and a corresponding development of further (novel) products is intended to be made possible, among other things, with the development shown in this patent application.

The following terms, which illustrate the need for the desired product electrification, may be listed (by way of example) as main points: Industry 4.0, condition monitoring (predictive maintenance), communication and data exchange, miniaturization, costs of present actuator system or media generation (compressed air, hydraulic pressure) as well as the service life of corresponding lines that are concomitantly moved, decentralized systems and the superordinate controller.

EP 2 845 072 B1 discloses what is known as a compact control device, which is intended for the fail-safe actuation of an electrical actuator. However, disadvantageously there is no consideration of the energy management and especially of the system behavior in the event of a power or energy failure or a consideration of the switch-off behavior.

### SUMMARY

The present invention is concerned with a core problem of electrical products, specifically the reliable and transparent actuation of actuators used therein, e.g. solenoids, independently of the feed input voltage and possible energy failures.

A safe switch-off in the form of a combination of “the switch-off itself” and the “time until a safe state of a connected actuator (hereinafter also synonymously referred to as actuator) is reached” is desirable. The prior art mentioned does not address either the need for a (passive) short-circuit path to dissipate the electrical power stored in an actuator more quickly (magnetic field, induction), or any other type of active demagnetization of the actuator to enable a clamping unit to be switched off and transferred to a safe (clamped) state. In the prior art mentioned, the energy dissipation in the actuator system is achieved only via heat or power loss, as a result of which the switching behavior in the event of a fault is too slow, especially for safety-relevant applications.

The invention is based on the object of specifying a control device that overcomes the above-mentioned disadvantages and in particular takes into account the system behavior in the event of a power or energy failure and enables safe switch-off behavior.

The object is achieved according to the invention by means of a control device having one or more of the features disclosed herein. Advantageous developments are defined below and in the claims.

A control device according to the invention with integrated energy conditioning and integrated energy management for actuating an electrically operated and/or controlled actuator comprises a controller unit (microcontroller) for generating an actuation signal for the actuator. It furthermore comprises a connection for connecting the control device to an external electrical energy supply that provides a grid voltage. Also provided is a circuit arrangement for the conditioning, rectification and conversion of the grid voltage into a first intermediate circuit DC voltage, wherein a level of the first intermediate circuit DC voltage is independent of a level of the (external) grid voltage. Furthermore, the control device comprises at least one electrical buffer store for the first intermediate circuit DC voltage for buffering a power necessary for maintaining at least one further voltage, derived from the first intermediate circuit DC voltage, for supplying power to the controller unit in the event of failure of the external electrical energy supply and for transferring the actuator to a safe state, for example in the event of failure of the external electrical energy supply.

According to the invention, the control device accordingly integrates an energy management concept that makes it possible, at any time, in particular even in the event of an energy failure at the power input of the control device, to perform safety-relevant functions (e.g. switching operations) in a manner unaffected by these events, and to transfer connected safety components (e.g. brakes or clamping units) to their safe state (braked or clamped) in a highly dynamic, i.e. relatively quick, manner.

The energy management concept furthermore decouples the feed-in voltage from the supply voltage of an actuator system, which is connected or to be connected to the control device, by way of the mentioned circuit arrangement that in particular may comprise an intermediate PFC (power factor correction) unit (PFC for short). As a result, voltage supplies (e.g. 110 V or 230 V) that are different on a worldwide or a country-specific basis are decoupled from the voltage supply of the actuator system, and any incorrect actuation on account of such different grid voltages is prevented. A faulty supply of energy to the system is therefore actively prevented (in the event of the product being switched on in another country with a different grid voltage). The control device is therefore able to be used or replaced worldwide without modifications or parameterizations.

The system architecture described here for the construction of fail-safe controllers or control devices preferably comprises the inclusion of energy management with energy conditioning, associated measurement technology and buffer storage.

In particular, the integration of energy conditioning and energy management preferably comprises detecting power or voltage failures (energy failure) on the AC side by providing a corresponding sensor means.

The energy conditioning preferably comprises conditioning the feed voltage (grid voltage; AC current/AC voltage) to a relatively high DC supply voltage level for actuating the safety components (i.e. the actuator system). Higher voltages advantageously enable faster loading and unloading processes in the actuator system.

In general, higher voltages allow faster switching cycles and correspondingly what is known as high-speed switching behavior, which can be particularly advantageous for safety-relevant applications.

This relatively high DC supply voltage is preferably buffer-stored in a downstream buffer store.

This buffer storage in particular ensures that the actuator voltage, i.e. the relatively high DC supply voltage mentioned, is smoothed. As a result, there is also temporary buffer storage of the conditioned power.

The entire system is able to be controlled and actively shut down by means of grid monitoring and the buffer storage mentioned if a power failure or voltage failure is detected on the grid side. Essential characteristic variables are able to be stored correctly in the microcontroller, wherein the last active state is maintained using information technology.

The microcontroller may also preferably actively communicate feedback regarding the power failure to a superordinate controller (PLC).

Provision is furthermore preferably made for a lower voltage, preferably a 24 V voltage, to be derived from the relatively high DC supply voltage.

In addition, the mentioned lower voltage may be read via external connections of the control device by a superordinate controller (e.g. a PLC), which may be connected to the control device. Feedback that the energy conditioning in the control device is functioning is then accordingly preferably given to the PLC.

The lower voltage may also be provided simultaneously as an external power supply via external connections of the control device.

A possible external power supply for the control device with the lower voltage as input preferably operates in parallel, and may therefore be connected simultaneously (redundantly). This enables the low voltage to be decoupled from the availability of the grid voltage.

Furthermore, at least an even lower voltage (e.g. 5 V, possibly 3.3 V) can be derived from the low voltage. This even lower voltage is preferably used to supply power to the controller unit (microcontroller) and any logic modules present in the controller unit.

The following configurations of the control device according to the invention have proven to be particularly advantageous:

In one configuration of the control device according to the invention, the circuit arrangement for the conditioning, rectification and conversion of the grid voltage comprises a power factor correction filter in the form of a step-up converter or a PFC input stage.

The power factor correction filter advantageously ensures an increased active power component (in comparison to a reactive power component).

In one configuration of the control device according to the invention, the first intermediate circuit DC voltage is able to be adjusted in principle as desired and independently of a value of the grid voltage, preferably to a value greater than a peak value of the grid voltage, in particular to a value greater than the peak value of a 230 V grid voltage.

The advantages of such an increased voltage have already been pointed out above.

In one configuration of the control device according to the invention, provision is made for a size of the buffer store for the first intermediate circuit DC voltage, with respect to a power that is buffer-stored or is able to be buffer-stored therein, to correspond at least to a maximum power required by an actuator that is permissibly able to be connected to the control device for transfer to a safe final position (that is to say to a safe state).

Specifically, it may be advantageous if a size of the buffer store for the first intermediate circuit DC voltage is selected such that a safe shutdown of the largest actuator, which according to the data sheet of the control device is still permissibly able to be connected to the control device, is guaranteed. This means that a size of the buffer store, with respect to a power that is buffer-stored therein, corresponds at least to a maximum power required by an actuator, which according to the data sheet is permissibly able to be connected to the control device, for safe shutdown, that is to say the movement into a position that is able to be maintained permanently (e.g. clamped or braked).

In one configuration of the control device according to the invention, the at least one further derived voltage is derived from the first intermediate circuit DC voltage, wherein the at least one further derived voltage and optionally additional derived voltages provide a sequential energy supply in order to supply electrical power to one or more further components of the control device, namely at least the controller unit, and/or internal and external communication interfaces.

The advantages of such a configuration have also already been pointed out above. In particular, it enables at least temporarily continued operation of all or at least some components irrespective of the state of an external energy supply (grid voltage).

In one configuration of the control device according to the invention, the at least one further derived voltage and optionally additionally derived voltages is/are lower than the first intermediate circuit DC voltage in terms of absolute value, wherein preferably the grid voltage is 110-230 V AC, the intermediate circuit DC voltage is 380 V DC, the at least one further derived voltage is 24 V DC and the optionally additionally derived voltages are 5 V DC and 3.3 V DC.

These values have proven to be particularly advantageous in practice and according to the studies of the applicant, in particular in the context of safety-relevant uses, e.g. for brakes or clamping units.

In one configuration of the control device according to the invention, the at least one further derived voltage or optionally additionally derived voltages are DC voltages, whereas the grid voltage is preferably an AC voltage.

Reference has already been made to this above.

In one configuration of the control device according to the invention, said control device has at least one external connection, wherein the at least one further derived voltage or at least one optionally additionally derived voltage is applied to the external connection of the control device.

This is used by an external superordinate controller to capture this voltage (in particular as a kind of status signal, which indicates that the energy supply and conditioning in the control device is functioning correctly).

Alternatively, the external connection is used to supply electrical energy to external components, e.g. external sensor means (in particular position sensors for the actuator).

As yet another alternative, the external connection may be used as an external voltage input for externally supplying this voltage to the control device, e.g. by way of a superordinate control unit (PLC). This voltage is then able to be converted within the control device to supply power to particular components of the control device.

This functionality allows for a particularly flexible use of the control device.

In one configuration of the control device according to the invention, the controller unit is, or is able to be, supplied with power by the at least one further derived voltage or by an optionally additionally derived voltage or, in the case of a corresponding configuration, by an external power supply at the external connection, if necessary after prior conversion of a voltage provided externally, as mentioned above.

This functionality also allows for a particularly flexible use of the control device.

In one configuration of the control device according to the invention, said control device has at least one sensor means for capturing the grid voltage and for detecting failure of the external electrical energy supply and for transmitting corresponding signals to the controller unit such that the latter is able to initiate or cause a safe shutdown, as explained above.

### BRIEF DESCRIPTION OF THE DRAWINGS

Further properties and advantages of the invention emerge from the following description of exemplary embodiments with reference to the drawing.

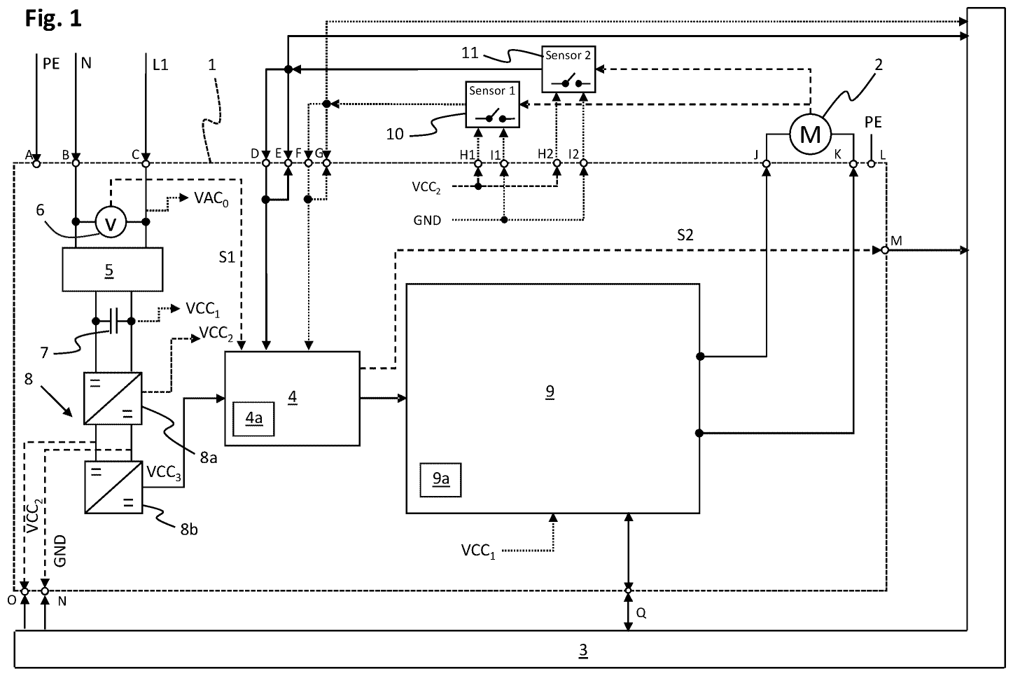

The single FIGURE, FIG. 1 shows a possible configuration of the control device according to the invention.

### DETAILED DESCRIPTION

In FIG. 1, reference sign 1 denotes the control device according to the invention. Reference sign 2 denotes an actuator (in this case an electric motor) connected to the control device. Reference sign 3 stands for a superordinate control unit in the form of a PLC. The reference signs A to O stand for inputs/outputs (or corresponding connections) of the control device 1; the associated arrows symbolize input or output signals (depending on the direction of the arrow). Reference sign 4 denotes a microcontroller (μC), and reference sign 5 denotes a PFC, i.e. a power factor correction filter in the form of a step-up converter or a PFC input stage.

A grid voltage is applied to the PFC 5 (between N and L1 or at the connections B and C), which is 230 V AC without limitation, in this case referred to as VAC₀. The connections at least at B and C therefore represent a connection for connecting the control device 1 to an external electrical energy supply, which provides a grid voltage. A sensor means 6 in the form of a voltmeter, which measures or monitors the grid voltage, is connected in parallel with the PFC 5 between the connections B and C. A corresponding measuring/monitoring signal S1 is provided for further use, e.g. state monitoring or fault analysis, at the microcontroller 4 (dashed arrow in FIG. 1). The microcontroller 4, for its part, is able to generate a corresponding signal S2 and provide it at the connection M for use by the PLC 3.

The PFC 5 generates a higher (in terms of absolute value, in particular in relation to a peak value [symbol] of the grid voltage VAC₀) (DC) voltage VCC₁ of e.g. 380 V from the grid voltage VAC₀, which in this case is referred to as the first intermediate circuit DC voltage VCC₁. For this purpose, the grid voltage VAC₀ is conditioned, rectified, converted and transformed into the first intermediate circuit DC voltage, i.e. the voltage VCC₁, VCC₁>> [symbol] , which has already been mentioned, wherein a level of the first intermediate circuit DC voltage VCC₁ is preferably independent of a level of the (external) grid voltage. The following is known to apply in this case:

$$V {AC}_{0} = \frac{\sqrt{2}}{} .$$

An electrical buffer store in the form of a capacitor 7 is connected downstream of the PFC 5 and parallel therewith, and will be discussed in more detail below.

Further components of a circuit arrangement 8 are located downstream of the capacitor 7. In this case, and without limitation, this circuit arrangement 8 comprises, in addition to the PFC 5 and downstream of the capacitor 7, two DC/DC voltage converters 8a, 8b, which successively derive and provide (DC) voltages VCC₂ and VCC₃ from the first intermediate circuit DC voltage VCC₁, as shown. Without limitation, VCC₁=380 V DC, VCC₂ is 24 V DC, and VCC₃ is 5 V DC. Further voltages may also be provided (derived) by means of an appropriate development, e.g. 3.3 V DC. GND stands for the ground potential. In this case, the voltage VCC₁ is also referred to as first intermediate circuit DC voltage, as has already been mentioned.

According to FIG. 1, the voltage or intermediate circuit DC voltage VCC₁ is applied to a safety circuit 9, which is described in a parallel patent application of the applicant, and is provided via this at the connections J and K to operate the actuator 2. The safety circuit 9 is preferably designed in terms of circuitry to change the polarity of the voltage at the output J/K to the actuator 2, which enables advantageous high-speed actuation.

The voltage VCC₂ is output, inter alia, at the connection O. However, this connection may advantageously also be used to externally provide a corresponding voltage for the control device 1, for example by way of the PLC 3. Connection N is at ground potential GND. A voltage VCC₂ provided externally at N, O is able to be converted to the voltage VCC₃ by the converter 8b before it is used, for example, to supply power to the microcontroller 4.

The voltage VCC₂ is also used to supply power to two position sensors 10, 11 (“sensor 1”, “sensor 2”), which are designed to capture a location or position of the actuator 2, via the connections H1 and H2 (ground potential GND at I1 and I2). Signals supplied by the position sensors 10, 11 are applied to D and F for use by the microcontroller 4 and are provided (after appropriate duplication) at E and G for the PLC 3.

The voltage VCC₃ is used in the present exemplary embodiment specifically for supplying power to the microcontroller 4, as already mentioned.

The electrical buffer store (capacitor) 7 for the first intermediate circuit DC voltage VCC₁ is used for buffering a power necessary for maintaining at least the voltage, derived from the first intermediate circuit DC voltage VCC₁, in this case specifically the voltage VCC₃ for supplying power to the microcontroller 4 in the event of failure of the external electrical energy supply and for transferring the actuator 2 to a safe state, for example in the event of failure of the external electrical energy supply.

The connections A and L are used to connect protective conductors for safely capturing and dissipating any fault currents. Electrical power may be supplied to at least the microcontroller 4 and/or corresponding communication interfaces via the external connection Q.

The feed voltage (grid voltage) at the connections B and C is therefore initially conditioned to VCC₁ by way of the arrangement shown in FIG. 1. In other words, the AC-side feed voltage at the connections A-C or B and C is transformed by the PFC 5 into a DC voltage with VCC₁. Where VCC₁>> [symbol] , higher, grid-voltage-independent voltages VCC₁ are available for safety-relevant actuators (e.g. actuator 2). The PFC 5 preferably processes all grid voltages that are commonly used worldwide between 100 V and 230 V or 240 V. VAC₀ denotes the grid voltage, i.e. 230 V. From an electrical point of view, this is an “RMS value”. The peak value is greater, and in the example mentioned is 230 V·\sqrt{2}=230 V·1.414≈325 V. A comparison is intended to be carried out against this peak value here. Peak values are usually indicated in the literature with a “roof” above the relevant symbol:

$$= {V AC}_{0} \cdot \sqrt{2} = 230 V \cdot 1.414 \approx 325 V , {V CC}_{1} ≫$$

The connections N and O function selectively as input or output for the derived voltage VCC₂. The derived or conditioned voltage VCC₂ is output, for example, to a superordinate controller (PLC 3) for control thereby. The connections mentioned are also used as inputs or as information source for the PLC 3 in order to ascertain whether the energy conditioning in the control device 1 is functioning correctly.

In particular, the superordinate PLC 3 is able to itself provide the voltage VCC₂ of e.g. 24 V and therefore “overwrite” the 24 V generated in the control device 1 itself in order to independently supply the relevant voltage of 24 V to the control device 1. This enables the voltage VCC₂ to be decoupled from the availability of a grid voltage. The microcontroller 4 also continues to operate at the connections A-C in terms of logic in the event of a power failure, as long as the PLC 3 provides the required voltage. The sensor system, that is to say in particular the position sensors 10 and 11 or the grid voltage sensor system 6, also continues to work fully and continues to provide status information regarding the state of the actuator 2 or, in particular, a clamping system (or any other connected system that comprises the actuator 2) and the grid voltage.

The described derivation of a 24 V voltage VCC₂ from the intermediate circuit DC voltage VCC₁ shows the advantages of a sequential energy supply downstream of the PFC 5 and the energy storage unit (buffer store or capacitor) 7: An energy failure is able to be detected via a sensor system (sensor means 6) and reported to the microcontroller 4. If the energy supply fails, at least the voltages VCC₂ and VCC₃ continue to be generated via the power in the energy storage unit 7, and so voltage continues to be supplied to the μC 4 and the complete logic/sensor system (e.g. position sensors 10 and 11). The μC 4 therefore continues to operate unaffected for a certain time t (t>0) despite a power failure. During this time t, the actuator 2 and accordingly a clamping system or the like operated thereby is therefore able to be shut down in a controlled and power-equivalent manner (i.e. with the nominally required power, that is to say without compromising the function), which corresponds to a transfer to a safe state, e.g. “clamped”. During this time t, status reports to or for the superordinate controller (PLC 3) are also preferably generated and output in a controlled manner (at output M). During this time t, system-relevant information is also preferably stored in a non-volatile memory area (EEPROM) of μC 4, so that it is available after the power supply has been restored. This memory area is indicated with the reference sign 4a in FIG. 1. It can, without limitation, also be designed separately from the μC 4 or even from the control device 1.

The described integration of controlled, fast (high-speed) switching behavior enables short switching cycles using the high voltage supply of VCC₁≥380 V, which is provided by the PFC 5 and is (far) above the peak voltages [symbol] of the (worldwide) feed voltages VAC₀ of 110 V or 230 V. High voltages ensure fast loading and unloading of the actuator system and therefore short reaction times (safety for humans and machines).

When the actuator 2 is switched off, the polarity of the voltage may be reversed. As a result, a magnetic field that is regularly present in the actuator system is able to be removed as quickly as possible in order to transfer the actuator 2 or a clamping element or the like that is moved thereby, to a safe (clamped) state. In general, this enables the actuator system (the actuator 2 or a safety component) to be overexcited on both sides by means of a semiconductor relay 9a preferably present in the safety circuit 9, both when releasing and when disengaging the actuator system.

The described high-speed switch-off behavior is possible in this case due to the energy buffer storage in the capacitor 7 even in the event of a grid failure. In this case, the grid failure is identified via the sensor system (in this case the sensor means 6). If a grid failure is identified, so much power is available in the capacitor 7 at PFC level (i.e. at 380 V, for example) that it is possible to transfer the actuator 2 or a connected safety component to its safe state in a controlled manner and at full power and full speed. In this way, the connected safety component never “sees” a power failure.

1. A control device (1) with integrated energy conditioning and integrated energy management for actuating an electrically operated and/or controlled actuator (2), the control device (1) comprising:
a controller (4) for generating an actuation signal for the actuator (2);
a connection (A-C) for connecting the control device (1) to an external electrical energy supply that provides a grid voltage (VAC₀);
a circuit arrangement (8) for the conditioning, rectification and conversion of the grid voltage (VAC₀) into a first intermediate circuit DC voltage (VCC₁), wherein a level of the first intermediate circuit DC voltage (VCC₁) is independent of a level of the grid voltage (VAC₀); and
at least one electrical buffer store (7) for the first intermediate circuit DC voltage (VCC₁) for buffering a power necessary for maintaining at least one further voltage (VCC₂, VCC₃), derived from the first intermediate circuit DC voltage, for supplying power to the controller (4) in the event of failure of the external electrical energy supply and for transferring the actuator (2) to a safe state, in an event of failure of the external electrical energy supply.

2. The control device (1) as claimed in claim 1, wherein
the circuit arrangement (8) for the conditioning, rectification and conversion of the grid voltage comprises a power factor correction filter comprising a step-up converter or a PFC input stage (5).

3. The control device (1) as claimed in claim 1, wherein
the first intermediate circuit DC voltage (VCC₁) is adapted to be adjusted in principle as desired and independently of a value of the grid voltage (VAC₀).

4. The control device (1) as claimed in claim 3, wherein
the first intermediate circuit DC voltage (VCC₁) is adapted to be adjusted to a value greater than a peak value [symbol] of the grid voltage (VAC₀).

5. The control device (1) as claimed in claim 1, wherein
a size of the buffer store (7) for the first intermediate circuit DC voltage (VCC₁), with respect to a power that is buffer-stored or is adapted to be buffer-stored therein, corresponds at least to a maximum power required by the actuator (2) that is permissibly adapted to be connected to the control device (1) for transfer to a safe final position.

6. The control device (1) as claimed in claim 1, wherein
the at least one further derived voltage (VCC₂, VCC₃) is derived from the first intermediate circuit DC voltage (VCC₁), and the at least one further derived voltage (VCC₂) provides a sequential energy supply in order to supply electrical power to one or more further components of the control device (1), including at least one of the controller (4), or internal and external communication interfaces.

7. The control device (1) as claimed in claim 6, wherein
the at least one further derived voltage (VCC₂, VCC₃) is derived from the first intermediate circuit DC voltage (VCC₁) and the at least one further voltage (VCC₃).

8. The control device (1) as claimed in claim 1, wherein
the at least one further derived voltage (VCC₂) is lower than the first intermediate circuit DC voltage (VCC₁) in terms of absolute value.

9. The control device (1) as claimed in claim 6, wherein the grid voltage is 110-230 V AC, the intermediate circuit DC voltage (VCC₁) is 380 V DC, the at least one further derived voltage (VCC₂) is 24 V DC.

10. The control device (1) as claimed in claim 9, wherein the at least one further derived voltage includes additionally derived voltages (VCC₃) that are 5 V DC and 3.3 V DC.

11. The control device (1) as claimed in claim 1, wherein
the at least one further derived voltage (VCC₂) is a DC voltage, and the grid voltage (VAC₀) is an AC voltage.

12. The control device (1) as claimed in claim 1, further comprising
at least one external connection (N, O); and
the at least one further derived voltage (VCC₂) is applied to the external connection (N, O) in order for the at least one further derived voltage to be captured by an external superordinate controller (3) or to supply electrical energy to external components; or
the external connection (N, O) is used as an external voltage input for externally supplying this voltage (VCC₂) to the control device (1).

13. The control device (1) as claimed in claim 1, wherein
the at least one further derived voltage (VCC₂) or at least one additionally derived voltage (VCC₂) is applied to the external connection (N, O) in order for the at least one further derived voltage to be captured by an external superordinate controller (3) or to supply electrical energy to external components or at least one optionally additionally derived voltage (VCC₂).

14. The control device (1) as claimed in claim 1, wherein
power is supplied or is adapted to be supplied to the controller (4) by the at least one further derived voltage.

15. The control device (1) as claimed in claim 1, wherein
power is supplied or is adapted to be supplied to the controller (4) by an optionally additionally derived voltage (VCC₃) or by an external supply at an external connection (N, O) of the control device.

16. The control device (1) as claimed in claim 1, further comprising:
at least one sensor (6) configured to capture the grid voltage (VAC₀) and for detecting failure of the external electrical energy supply and for transmitting corresponding signals (S1) to the controller (4).
